(19) United States
(12) Patent Application Publication
(10) Pub. No.: US 2005/0003104 A1
(43) Pub. Date: Jan. 6, 2005

(54) Method for producing a uv-absorbing transparent wear protection layer

(76) Inventors: Manfred Neumann, Dresden (DE); Mario Krug, Neustadt (DE); Nicolas Schiller, OT Helmsdorf (DE); Thomas Kuhnel, Pirna (DE)

Correspondence Address: GREENBLUM & BERNSTEIN, P.L.C., 1950 ROLAND CLARKE PLACE, RESTON, VA, 20191, US

(21) Appl. No.: 10/493,061

(22) PCT Filed: Oct. 19, 2002
(86) PCT No.: PCT/EP02/11728

(30) Foreign Application Priority Data
Oct. 31, 2001 (DE) 101 53 760.3

(51) Int. Cl. H05H 1/24

(52) U.S. Cl. 427/569; 427/255.7

(57) ABSTRACT

The invention relates to a method for producing UV-absorbing transparent wear protection layers by vacuum coating in which at the same time or immediately one after the other at least one inorganic compound that forms layers with high wear resistance and an inorganic compound that forms layers with high UV-absorption are deposited on a substrate respectively by means of reactive or partially reactive plasma-aided high-rate deposition.

The invention relates to a method for producing by vacuum coating a UV-absorbing wear protection layer that is transparent in the visible range. Preferred applications of such layers are transparent wear protection layers on plastics for exterior applications, e.g., for windows on vehicles and buildings and for other transparent or decorative plastic parts.

It is known to produce transparent wear protection layers by varnishing methods with organic hard varnishes. However, such layers have only a limited wear resistance and in general have an unsatisfactory weather resistance and UV resistance.

By applying transparent oxide layers in vacuum much higher wear resistances are achieved with much lower material expenditure. The coating is carried out by means of vaporization, sputter or plasma CVD methods (G. Kienel: Vakuumbeschichtung, Vol. 5, VDI Verlag, Düsseldorf, 1993). However, the inorganic oxide layers produced in this way have a much lower flexibility than the organic coatings produced by varnishing. The good properties of the oxide layers that can be achieved through vacuum coating are thus impaired during use and further processing of the coated substrates.

Attempts have therefore been made to combine the high flexibility of the organic coatings with the high wear resistance of the inorganic oxide layers. One example is the so-called “organically modified ceramic layers” (ORMOCER layers) that are produced according to the sol-gel method and applied like varnish layers (R. Kasemann, H. Schmidt: New Journal of Chemistry, Vol. 18, 1994, Part 10, page 1117). However, they require similarly large layer thicknesses as conventional varnish layers. Moreover, although the wear resistance is better than with varnish layers, it is by no means as good as with thin oxide layers applied in vacuum.

It is also known to produce organic layers with inorganic oxide content such that the organic layers are deposited in vacuum with the aid of plasma polymerization, whereby metallo-organic or silicon-organic vapors are used as monomer for the plasma polymerization and through simultaneous oxygen inlet metal oxide or silicon oxide molecules are also formed and stored in the growing organic polymer layer (JP 2/99933). The oxide content in the organic polymer layer can be varied depending on the monomer used and depending on the oxygen content. In this manner harder or less hard layers can be deposited which feature good wear resistances as well as a relatively high flexibility. However, this method has the disadvantage that in order to achieve layers of the right quality, only deposition rates of a few nanometers per second are possible. This method is therefore unsuitable for the economic coating of large areas.

It is known to avoid this disadvantage by combining the method of plasma polymerization with the method of plasma-aided high-rate deposition (DE 195 48 160 C1). The plasma-aided high-rate deposition permits the depositing of hard, wear resistant oxide layers with coating rates of up to 1000 nanometers per second or more, while the simultaneous plasma polymerization of the monomers released into the deposition zone causes an increased flexibility of the oxide layers deposited at a high rate. However, the layer-substrate composites produced in this manner have an inadequate UV resistance for many applications. Although the layers themselves are UV-resistant in many cases, in particular with a high inorganic oxide content, the UV radiation passing through the layer damages the plastic substrate lying below it and thus impairs the adhesive strength of the wear protection layers on the substrate.

When depositing transparent wear protection layers through plasma CVD it is known to arrange a UV-absorbing intermediate layer under the actual wear protection layer in order to prevent the UV rays from reaching the plastic substrate, thus avoiding damage to the substrate (U.S. Pat. No. 5,156,882). Both the UV-absorbing intermediate layer (ZnO, TiO₂, CeO₂, V₂O₅) and the wear protection layer are deposited by means of plasma CVD with coating rates of less than 1 nm/s, so that this method is not suitable for the coating of large amounts of substrate at an acceptable cost.

It is further known when depositing wear protection layers by means of plasma CVD to incorporate the UV-absorbing material (oxides, silicides, carbides, borides, nitrides, sulfides, fluorides, selenides, or tellurides of the elements La, Ce, Zn, In, Sn, Al, Si, Ge, Sb and/or Bi) in the wear protection layer by means of a PVD method preferably by sputtering (DE 198 24 364 A1). Here the depositing rate is also limited by the plasma CVD process or the PVD process (sputtering) to values in the order of magnitude of 1 nm/s, so the process is not suitable either for coating large amounts of substrate at low cost.

Finally, it is known when depositing wear protection layers by means of plasma CVD to incorporate the UV-absorbing material (oxides, oxynitrides or nitrides of Ce, Zn, Ti, Va, Pb, Ni or Sn) in the wear protection layer or a bottom layer by the evaporation of organic compounds with or without plasma action (DE 199 01 834 A1). Here, too, only depositing rates of a few nanometers per second are achieved, so a process duration of approx. 10 min. results for depositing a layer system, which does not permit a cost-effective coating of large amounts of substrate.

The object of the invention is to create a method for depositing UV-absorbing wear protection layers that are transparent in the visible range by means of vacuum coating with which higher deposition rates and thus lower coating costs are possible than with the previously known methods. The method should be suitable in particular for depositing strongly adhesive, weather-resistant and UV-resistant layers with high wear resistance on plastic surfaces.

The object is attained through a method with the features of claim 1. Advantageous embodiments of the method are described in claims 2 through 22.

An essential feature of the invention is the use of reactive or partially reactive plasma-aided high-rate deposition to deposit an inorganic compound for UV absorption in combination with the plasma-aided high-rate deposition for depositing an inorganic compound for wear protection. Previously inorganic or also organic compounds for UV protection were deposited only by methods with a low coating rate, such as, e.g., through plasma CVD or sputtering, because the UV-absorbing properties were not otherwise achieved. Due to the high evaporation temperatures, vacuum coating methods with a high coating rate, such as, e.g., electron beam high-rate evaporation, lead in part to a decomposition of the UV-absorbing compounds and thus to the loss of the UV-absorbing properties. It has now been found that with the deposition of an inorganic compound for wear protection and an inorganic compound for UV-absorption through reactive or partially reactive plasma-aided high-rate deposition at the same time or immediately one after the other, layers can be deposited that feature an excellent UV-absorption in addition to a high wear resistance, despite a very high coating rate.

Above all SiOₓ and AlₓO_{y} are suitable as inorganic compounds for wear protection, especially as these compounds can be deposited at particularly low cost. SiOₓ can be deposition by partially reactive plasma-aided electron beam high-rate evaporation of quartz with coating rates of over 50 nm/s, preferably several 100 nm/s to over 1000 nm/s. The use of quartz granules is particularly cost-effective and suitable. AlₓO_{y} can be deposited through reactive plasma-aided high-rate evaporation of aluminum by means of electron beam evaporation or boat evaporation with coating rates of several 100 nm/s. The reactive plasma-aided high-rate boat evaporation of aluminum wire is particularly cost-effective.

The depositing of the UV-absorbing layer advantageously takes place by the partially reactive or reactive plasma-aided high-rate evaporation of a UV-absorbing compound or a nonvolatile component of such a compound with coating rates of at least 10 nm/s, preferably 20 to 200 nm/s. The oxides and oxynitrides of Ce, Zn, Ti, Va, Pb, Ni and Sn, i.a., are possible as inorganic compounds for the UV-absorption.

According to the invention a particularly good UV-absorption is achieved if the inorganic compound for the UV-absorption is evaporated by partially reactive plasma-aided high-rate evaporation of CeO₂, TiO₂ or ZnO or by fully reactive plasma-aided high-rate evaporation of Zn, respectively using oxygen as the reactive gas, immediately before, during or after the deposition of the inorganic compound for wear protection. The coating rates that can be used are preferably 20 to 200 nm/s, so that, due to the low layer thicknesses or the smaller contents in the layer, approximately the same coating times are possible as when depositing the inorganic compounds for wear protection.

The use of plasma sources with high plasma density on the basis of vacuum arc discharges, hollow cathode glow discharges or ECR microwave discharges are recommended in order to successfully carry out the method. The use of hollow cathode arc sources that can be arranged next to one another in appropriate numbers for coating large areas has proven to be particularly suitable.

The inorganic compound for wear protection and the inorganic compound for UV-absorption can be deposited on the substrate to be protected in the form of separate layers one after the other in a different order. It is also possible to deposit the inorganic compound for wear protection and the inorganic compound for UV-absorption on the substrate at the same time in the form of one or more consecutive mixed layers. The starting materials for the two different compounds are thereby preferably evaporated from two crucibles arranged next to one another or concentrically to one another. If both starting materials have approximately the same evaporation temperature, they can also be mixed together before evaporation and evaporated from the same crucible.

In order to achieve high productivity it is advantageous to deposit each one of the consecutive layers in a separate deposition zone and to guide the substrate to be coated at uniform speed over the deposition zones arranged one after the other. If the productivity requirements are not so high, and an identical or similar layer is to be deposited several times in a row, the substrate can also be guided over the same deposition zone several times.

To further improve the layer properties it is advantageous in addition to let in vaporous organic monomers in one or more of the deposition zones. Through the highly dense plasma, during the plasma-activated high-rate deposition the let in organic molecules or fractions thereof are incorporated into the deposited layer and partially cross-linked with one another. This leads to an increased elasticity and to a lower brittleness of the layers. Moreover, an improved adhesive strength, improved antifriction properties, a change in the wetting properties or also a further improvement in the UV-absorption can be achieved, depending on the choice of monomer.

Depending on whether the organic molecules are to be incorporated over the layer thickness uniformly or in the form of a gradient, it is expedient to let in the organic monomer uniformly over the entire deposition zone or preferably at the beginning, in the middle or at the end of the deposition zone. It can also be advantageous to ensure through an appropriate arrangement of monomer inlet, high-rate evaporation and plasma sources that first only the molecules of the organic monomer are deposited on the substrate and only then the molecules of the inorganic compound.

A particularly advantageous embodiment of the invention lies in guiding the substrate to be coated over three deposition zones successively and depositing
an SiOₓ layer for wear protection in the first deposition zone
a ZnOₓ layer for UV-absorption in the second deposition zone, and
another SiOₓ layer for wear protection in the third deposition zone
   and letting in an organic monomer in the first and third deposition zone. It is thereby advantageous in the interest of low coating costs to deposit the SiOₓ layer through the plasma-aided electron beam high-rate evaporation of quartz granules and the ZnOₓ layer through the plasma-aided reactive high-rate evaporation of zinc.

It is also possible to first deposit the ZnOₓ layer for the UV-absorption and subsequently one or more SiOₓ layers for wear protection. Depositing several SiOₓ layers in several consecutive separate deposition zones is particularly advantageous in the coating of temperature-sensitive plastic substrates, because a heat transfer can take place between the SiOₓ coatings into the interior of the substrate.

A further advantageous embodiment of the invention lies in guiding the substrate uniformly over two deposition zones and depositing
a SiOₓ/CeOₓ mixed layer with higher CeOₓ content in the first deposition zone, and
a SiOₓ/CeOₓ mixed layer with lower CeOₓ content in the second deposition zone, whereby in the two deposition zones the SiOₓ and the CeOₓ are respectively evaporated from separate, immediately adjacent evaporation crucibles through plasma-aided electron beam high-rate evaporation of quartz granules or CeO₂ granules and the CeOₓ content in the SiOₓ/CeOₓ mixed layer is adjusted through the dwell time of the electron beam on the quartz or CeO₂ evaporation crucible. Moreover, it is advantageous to let in an organic monomer at the beginning of each deposition zone. This variant has the advantage that the SiOₓ as the inorganic compound for wear resistance and the CeOₓ as the inorganic compound for UV-absorption can be evaporated at the same time with the same electron beam. The deposition of the SiOₓ/CeOₓ mixed layer in two consecutive deposition zones is in turn advantageous when temperature-sensitive plastic substrates are to be coated because a heat transfer is possible between the two coatings into the interior of the substrate. In the coating of temperature-stable substrates or thin plastic films cooled by a cooling roll, the application of the SiOₓ/CeOₓ mixed layer can also take place at once in only one deposition zone.

When SiOₓ is used as the inorganic compound for wear protection, the UV-absorbing wear protection layers produced with the method according to the invention should feature a minimum thickness of approx. 5 μm in order to achieve a wear resistance comparable to that of glass.

With a multiple layer system of SiOₓ layers for wear protection and a ZnOₓ layer for UV-absorption, it is advantageous
to first arrange a 2 to 5 μm thick organically modified SiOₓ layer on the substrate, whereby the content of organic molecules in the side of the layer facing the substrate is zero to 100% and on the side of the layer facing away from the substrate is zero to 50%,
to arrange thereon a 0.2 to 0.5 μm thick ZnOₓ layer without organic modification, and
to arrange thereon a further 2 to 5 μm thick organically modified SiOₓ layer, whereby the content of organic molecules in the side of the layer facing the substrate is zero to 100% and in the side facing away from the substrate is zero to 30%.

The recommended total layer thickness is approximately 5 to 10 μm depending on the performance requirements and the associated degree of organic modification. The thickness of the UV-absorbing ZnOₓ layer should be approx. 0.2 to 0.5 μm depending on the UV-sensitivity of the substrate and on the application.

With a UV-absorbing wear protection layer using SiOₓ/CeOₓ mixed layers, the total layer thickness should likewise be approx. 5 to 10 μm depending on the performance requirements, whereby the CeOₓ content converted to the layer thickness should be approx. 0.5 to 2 μm depending on the requirements for UV-absorption, which corresponds to 5 to 50% of the SiOₓ content, depending on the SiOₓ thickness. It has proven to be advantageous when two SiOₓ/CeOₓ mixed layers are arranged one above the other, to select the CeOₓ content and the content of organic molecules in the mixed layer facing the substrate to be higher than in the mixed layer facing away from the substrate.

The method according to the invention will be explained in more detail on the basis of an exemplary embodiment and a relevant drawing.

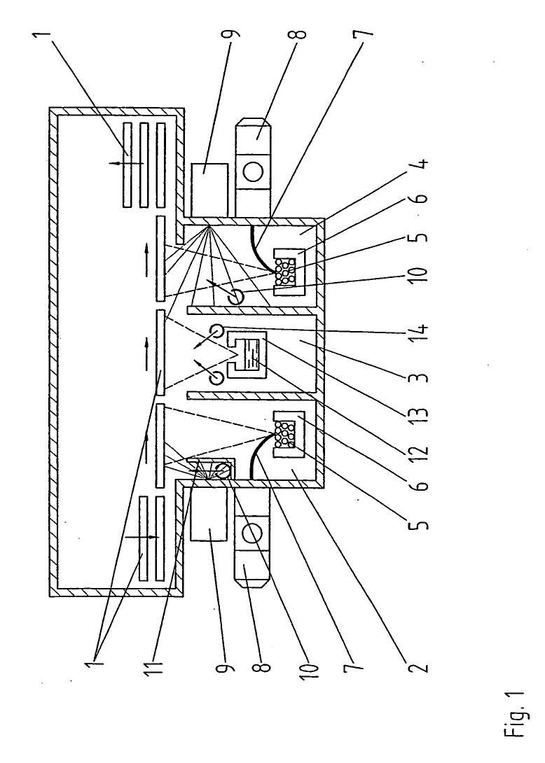

FIG. 1 shows diagrammatically a device for carrying out the method according to the invention, whereby the inorganic compound for wear protection and the inorganic compound for UV-absorption are deposited one after the other on plate-shaped plastic substrates 1 of polycarbonate. The plasma-aided high-rate deposition takes place in three deposition zones 2, 3 and 4 arranged one after the other over which the plastic substrates 1 are moved uniformly by means of a transport device (not shown).

SiOₓ, as the inorganic compound for wear protection, is deposited in the first deposition zone 2 through the electron beam high-rate evaporation of quartz granules 5 from water-cooled crucibles 6 rotating around the vertical axis. Depending on the width of the plastic substrate 1 to be coated, several crucibles 6 are arranged next to one another over the coating width. The electron beam 7 necessary for the evaporation is generated in an axial electron beam gun 8 and deflected over several crucibles 6 lying next to one another. The plasma activation in the deposition zone 2 takes place by means of one or more plasma sources 9 that act over the entire coating width. In the current example a row of hollow cathode arc sources arranged next to one another is provided in order to achieve a particularly high plasma density, above all at the beginning of the deposition zone 2. Nozzles 10 are provided in the direct vicinity of the plasma sources 9 to let in a vaporous organic monomer. In the present example hexamethyldisiloxane (HMDSO) is used because it leads to particularly favorable layer properties when incorporated into the SiOₓ layer. It is expedient to let in oxygen as reactive gas via the nozzles 10 in addition to the organic monomer in order to deposit highly transparent colorless SiOₓ layers. It has proven advantageous to carry out the plasma activation and the organic modification preferably at the beginning of coating, i.e., at the start of deposition zone 2. It is particularly advantageous for the adhesion of the organically modified SiOₓ layer to the plastic substrate 1 if at first only the molecules of the organic monomer and afterwards in addition the molecules and molecule fragments of the evaporated quartz granules 5 strike the plastic substrate 1, which can be achieved by a shielding 11 between the nozzles 10 for letting in the monomer, and the rest of the deposition zone 2. The average coating rate within the deposition zone 2 is approx. 400 nm/s, so that with a length of the deposition zone of 0.5 m and a substrate transport speed of 3 m/min, a thickness of the organically modified SiOₓ layer of approx. 4 μm is achieved. In this manner a layer is deposited in which the content of organic molecules on the side of the layer facing the substrate is almost 100% and on the side facing away from the substrate is approx. 20%.

In the second deposition zone 3, the deposition of ZnOₓ as the inorganic compound for UV-absorption takes place through plasma-aided, reactive evaporation of zinc 12. The evaporation takes place out of a thermally heated oven evaporator 13 with an emission slit for the zinc vapor which extends over the entire coating width. Oxygen is let in as the reactive gas via special nozzles 14 that likewise extend across the entire coating width. The special nozzles 14 are laid on a positive potential so that in this manner electrons are drawn from the plasma of the adjacent SiOₓ deposition zones 2 and 4 into the deposition zone 3 and there likewise produce a plasma. Through this plasma the zinc vapor emitted from the oven evaporator 13 and the oxygen emitted from the special nozzles 14 are excited and ionized, which leads to an improved chemical reaction between zinc and oxygen and to a densification of the ZnOₓ layer deposited in the deposition zone 3. The average ZnOₓ coating rate in the deposition zone 3 is approx. 40 nm/s so that with a length of the deposition zone of 0.5 m and a substrate transport speed of 3 m/min, a ZnOₓ layer of approx. 400 nm thickness is deposited.

Analogous to the first deposition zone 2, in the third deposition zone 4 another SiOₓ wear protection layer is deposited through electron beam high-rate evaporation of quartz granules 5. In contrast to the first deposition zone 2 a largely homogenous organic modification of the SiOₓ layer occurs here by letting in the organic monomer at a greater distance from the substrate and without special shielding between the nozzles 10 for letting in the monomer, and the rest of the deposition zone 4. Here too the organically modified SiOₓ layer is deposited with a coating rate of approx. 400 nm/s so that with a substrate transport speed of 3 m/min and a length of the deposition zone 4 of 0.5 m, a wear protection layer approx. 4 μm thick is deposited. The organic molecule content of the layer of is approximately constant across the layer thickness and is about 20%.

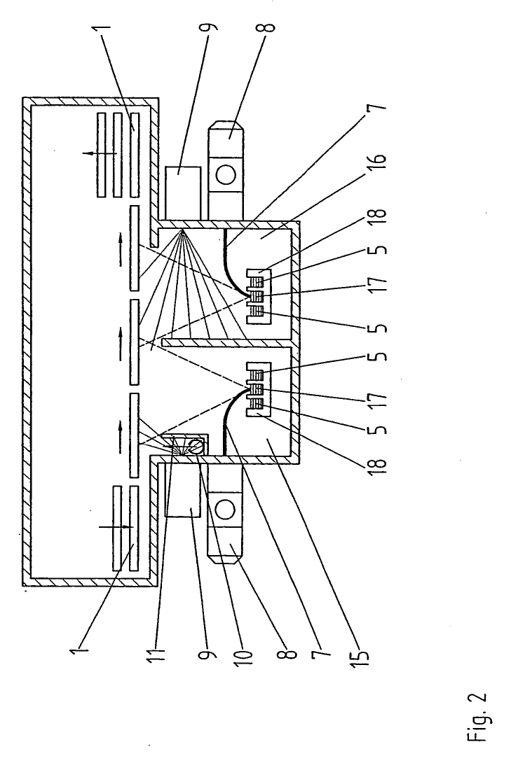

FIG. 2 shows a device for carrying out the method according to the invention according to another variant of the invention. The inorganic compound for wear protection and the inorganic compound for UV absorption are simultaneously deposited as a mixed layer on the substrate 1 to be protected. Due to the comparability to the first example given, polycarbonate plates should be considered as substrate and SiOₓ as the inorganic compound for wear protection. CeOₓ is used as the inorganic compound for UV-absorption. The plasma-aided high-rate deposition of the temperature-sensitive polycarbonate substrates with the SiOₓ/CeOₓ mixed layer is distributed over two deposition zones 15; 16 in order to render possible a heat equalization within the substrate between the two deposition zones and thus to prevent an overheating of the substrate surface.

In the first deposition zone 15 quartz granules 5 and CeO₂ granules 17 are evaporated simultaneously from several separate evaporation crucibles 6 arranged over the entire deposition width with the aid of one or more electron beams 7 that are generated in one electron beam gun 8 or several electron beam guns 8 arranged next to one another. One crucible 6 for the evaporation of quartz granules 5 and one crucible 6 for the evaporation of CeO₂ granules 17 can thereby be arranged alternately across the deposition width. As shown in FIG. 2, the quartz granules 5 and the CeO₂ granules 17 can also be evaporated from a concentrically structured double crucible 18, several of which are arranged next to one another over the deposition width. In the example shown the CeO₂ granules 17 is evaporated from the central part and the quartz granules 5 from the ring-shaped outer part of the double crucible 18 rotating around its vertical axis. The ratio of the SiOₓ and the CeOₓ in the deposited SiOₓ/CeOₓ mixed layer can be adjusted through the ratio of the dwell time of the electron beam 7 on the quartz granules 5 or the CeO₂ granules 17. The plasma activation and the monomer and reactive gas inlet into the first deposition zone take place as in the example of FIG. 1 with the aid of a number of plasma sources 9 and inlet nozzles 10. The arrangement of a shielding 11 between the inlet nozzles 10 and the rest of the deposition zone 15 has also proved to be expedient. The average coating rate for the deposition of the SiOₓ/CeOₓ mixed layer within the deposition zone 15 can be approx. 400 nm/s as with the pure SiOₓ coating so that with a length of the deposition zone of 0.5 m and a substrate transport speed of 3 m/min a SiOₓ/CeOₓ mixed layer approx. 4 μm thick can be deposited. The content of the CeOₓ by volume is thereby approx. 15%, which corresponds to a thickness content of the CeOₓ in the SiOₓ/CeOₓ mixed layer of approx. 0.6 μm.

A second SiOₓ/CeOₓ mixed layer with a thickness of approx. 4 μm is deposited in the second deposition zone 16 analogous to the first deposition zone 15. However, it is expedient to reduce the CeOₓ content in the layer compared with the deposition zone 15 to approx. 10% in order to achieve a greater hardness and wear resistance of the second SiOₓ/CeOₓ mixed layer. The thickness content of the CeOₓ in the second SiOₓ/CeOₓ mixed layer deposited in the deposition zone 16 is thereby approx. 0.4 μm. Moreover, in the present example the organic modification of the second SiOₓ/CeOₓ mixed layer has been omitted, since an increase in the layer flexibility can already be registered through the CeOₓ addition analogous to the addition of the organic molecules.

1. Method for producing UV-absorbing transparent wear protection layers by vacuum coating, characterized in that at the same time or immediately one after the other at least one inorganic compound that forms layers with high wear resistance and an inorganic compound that forms layers with high UV-absorption are deposited on a substrate respectively by means of reactive or partially reactive plasma-aided high-rate deposition.

2. Method according to claim 1, characterized in that the inorganic compound for the layer with high wear resistance is deposited through plasma-aided high-rate evaporation with coating rates of at least 50 nm/s, preferably 100 to 1000 nm/s.

3. Method according to claim 2, characterized in that SiOₓ is used as the inorganic compound for the layer with high wear resistance and is produced through plasma-aided high-rate evaporation of quartz, preferably of quartz granules.

4. Method according to claim 2, characterized in that AlxOy is used as the inorganic compound for the layer with high wear resistance and is produced through plasma-aided reactive high-rate evaporation of aluminum using an oxidizing reactive gas, preferably using oxygen.

5. Method according to claim 1, characterized in that the inorganic compound for the layer with high UV-absorption is deposited through the partially reactive or reactive plasma-aided high-rate evaporation of a UV-absorbing compound or a nonvolatile component of such a compound with coating rates of at least 10 nm/s, preferably 20 to 200 nm/s.

6. Method according to claim 5, characterized in that the oxides or oxynitrides of Ce, Zn, Ti, Va, Pb, Ni or Sn are used as the UV-absorbing compounds.

7. Method according to claim 5, characterized in that the inorganic compound for the UV-absorption is produced by partially reactive, plasma-aided high-rate evaporation of CeO2, ZnO or TiO2 using an oxidizing reactive gas, preferably using oxygen.

8. Method according to claim 5, characterized in that the inorganic compound for the UV-absorption is produced through reactive plasma-aided high-rate evaporation of Zn using an oxidizing reactive gas, preferably using oxygen.

9. Method according to claim 1, characterized in that the plasma for the plasma-aided high-rate deposition is produced through a vacuum arc discharge, a hollow cathode glow discharge or an ECR microwave discharge.

10. Method according to claim 9, characterized in that the plasma for the plasma-aided high-rate vaporization is produced through a hollow cathode arc discharge.

11. Method according to claim 1, characterized in that one or more layers of an inorganic compound for wear resistance and one or more layers of an inorganic compound for UV-absorption are deposited on the substrate to be protected one after the other in any order.

12. Method according to claim 1 characterized in that one or more mixed layers of an inorganic compound for wear resistance and an inorganic compound for UV-protection are deposited respectively on the substrate to be protected.

13. Method according to claim 11, characterized in that the individual layers are deposited in separate deposition zones on the substrate to be protected, whereby the substrate is guided at uniform speed over the deposition zones arranged one after the other.

14. Method according to claim 13, characterized in that the substrate is guided over the same deposition zone several times.

15. Method according to claim 13, characterized in that in addition vaporous organic monomers such as silicon-organic, metallo-organic or fluoro-organic compounds or hydrocarbons are admitted in at least one of the deposition zones for the organic modification of the deposited layers.

16. Method according to claim 15, characterized in that the inlet of the organic monomers takes place uniformly over the entire deposition zone.

17. Method according to claim 15, characterized in that the inlet of the organic monomers takes place chiefly at the beginning, in the middle or at the end of the deposition zone.

18. Method according to claim 17, characterized in that the inlet of the organic monomers takes place preferably at the beginning of the deposition zone so that first only the molecules of the organic monomer are deposited on the substrate and only afterwards the molecules of the inorganic compound.

19. Method according to claim 1, characterized in that
an SiOx layer for wear protection in the first deposition zone
a ZnOx layer for TV-absorption in the second deposition zone, and
another SiOx layer for wear protection in the third deposition zone
are deposited on a substrate moved uniformly over three deposition zones and an organic monomer is admitted in the first and third deposition zone.

20. Method according to claim 1, characterized in that
a SiOx/CeOx mixed layer with higher CeOx content in the first deposition zone, and
a SiOx/CeOx mixed layer with lower CeOx content in the second deposition zone,
are deposited on a substrate moved uniformly over two deposition zones, whereby in the two deposition zones the SiOx and the CeOx are evaporated respectively from separate, immediately adjacent evaporation crucibles through plasma-aided electron beam high-rate evaporation of quartz granules or CeO2 granules and the CeOx content in the SiOx/CeOx mixed layer is adjusted through the dwell time of the electron beam on the quartz or CeO2 evaporation crucible and whereby an organic monomer is admitted in each deposition zone.

21. Method according to claim 19, in which a substrate with a UV-absorbing wear protection layer is produced, characterized in that
first a 2 to 5 μm thick organically modified SiOx layer is deposited on the substrate, whereby the content of organic molecules on the side of the layer facing the substrate is zero to 100% and on the side of the layer facing away from the substrate is zero to 50%,
a 0.2 to 0.5 μl thick ZnOx layer without organic modification is deposited thereon, and
a further 2 to 5 μm thick organically modified SiOx layer is deposited thereon, whereby the content of organic molecules in the side of the layer facing the substrate is zero to 100% and in the side facing away from the substrate is zero to 30%.

22. Method according to claim 20 in which a substrate with a UV-absorbing wear protection layer is produced, characterized in that
first a 2 to 5 μm thick organically modified SiOx/CeOx mixed layer is deposited on the substrate, whereby the CeOx content is 10 to 50% and the content of organic molecules in the side facing the substrate is zero to 100% and in the side facing away from the substrate is zero to 50%, and
a further 2 to 5 μm thick organically modified SiOx/CeOx mixed layer is deposited thereon, whereby the CeOx content is 5 to 20% and the content of organic molecules in the side facing the substrate is zero to 100% and in the side facing away from the substrate is zero to 30%.
